(19) United States
(12) Patent Application Publication
(10) Pub. No.: US 2008/0144537 A1
(43) Pub. Date: Jun. 19, 2008

(54) VOICE-OVER-INTERNET PROTOCOL TELEPHONE SYSTEM WITH TELECONFERENCE FEATURES

(76) Inventor: Srinivas Vadhri, Cupertino, CA (US)

Correspondence Address: SCHWEGMAN, LUNDBERG & WOESSNER/EBAY, P.O. BOX 2938, MINNEAPOLIS, MN, 55402, US

(21) Appl. No.: 11/611,764

(22) Filed: Dec. 15, 2006

(51) Int. Cl. H04L 12/16

(52) U.S. Cl. 370/261

(57) ABSTRACT

System, method, data structures and software are disclosed wherein at least one end-user computer executes a calendaring application, wherein the calendaring application includes data representing an appointment for a teleconference, and wherein the appointment specifies one or more participants scheduled to join the teleconference. The end-user computer may include a VoIP software application adapted to establish a VoIP connection. The VoIP software application at least in part executes on the end-user computer to initiate a VoIP connection to the teleconference. Further the calendaring application executes on the end-user computer to at least in part communicate with the VoIP software application in order to initiate the VoIP connection.

### FIELD OF THE INVENTION

The inventive subject matter relates to telecommunications systems, for example to telephone systems as well as to decentralized telecommunications systems using voice-over-IP transmission for teleconferencing. Moreover, the inventive subject matter relates to the scheduling and initiation of voice-over-Internet protocol (VoIP) teleconferences.

### BACKGROUND

VoIP communications, such as telephone and/or video-phone communications, have become increasingly popular for a number of reasons. A VoIP connection path may travel through a centralized switch, for example as provided by a “public switched telephony network” (PSTN) or a mobile telephone system, or through a centralized server on the network, or peer-to-peer without requiring a centralized server.

### BRIEF DESCRIPTION OF DRAWINGS

FIGS. 1A and 1B are a schematic diagram of an example system according to the embodiments described herein;

FIG. 2 is a flow chart of an example method according to the embodiments described herein;

FIG. 3 is a schematic diagram of an example data structure according to the embodiments described herein; and

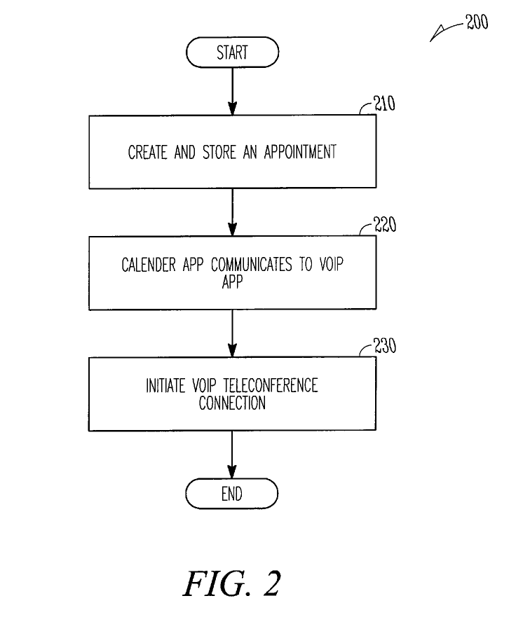

FIG. 4 is a schematic diagram of an example computing system according to the embodiments described herein.

### DETAILED DESCRIPTION

Example methods and systems to facilitate VoIP teleconference connections using a calendaring application are described. In the following description, for purposes of explanation, numerous specific details are set forth in order to provide a thorough understanding of example embodiments. It will be evident, however, to one skilled in the art that the present invention may be practiced without these specific details.

As described herein, according to one example embodiment, a calendaring application is used to establish a teleconference for a plurality of participants. The calendaring application may run locally on an end-user computer, or be implemented as a client-server application over a network. The calendaring application includes a number of parameters and functions that facilitate communication with and use of a VoIP teleconference capability, wherein, for example, a meeting organizer may determine which participants are enabled to conduct a teleconference over a VoIP connection, invite participants to participate over the participant's VoIP connection, and further wherein the participants may elect to participate in the teleconference using a VoIP connection if the organizer specifies the teleconference may be accessed using a VoIP connection. These example embodiments and many other example features and capabilities are described below.

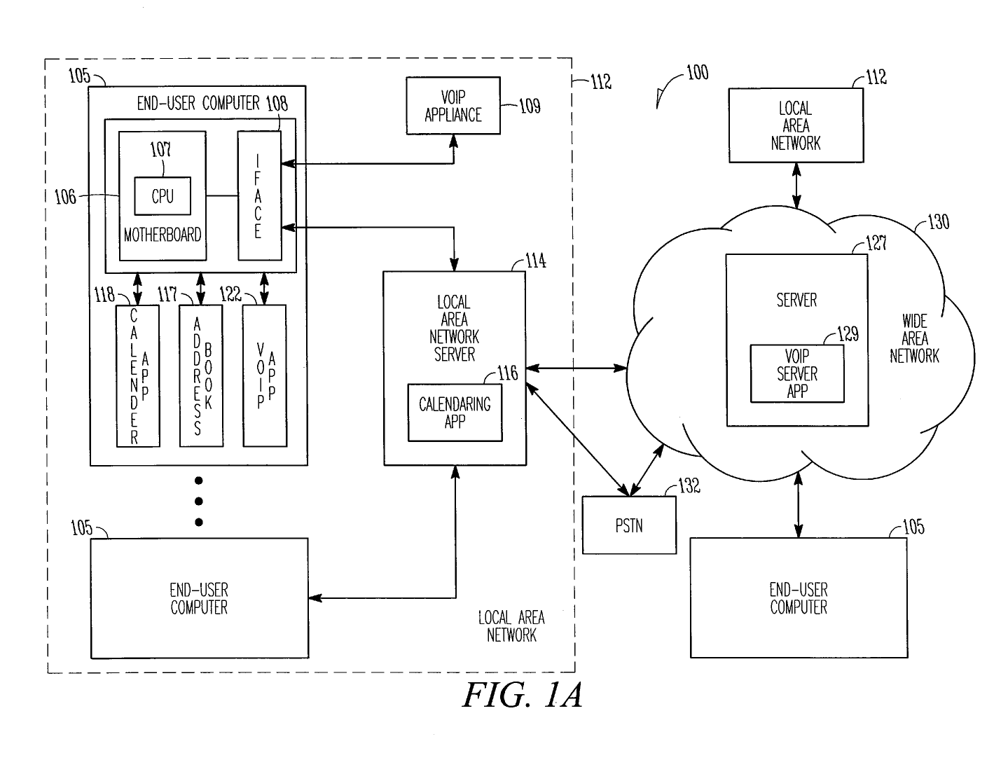

Referring now to FIG. 1A, there is illustrated a system 100 according to one example embodiment. A plurality of end-user client computers 105 are connected to at least one local area network 112. In various embodiments, client computers 105 may include desktop personal computers (PC), laptop computers, handheld devices, wireless appliances (e.g., cellular phones or personal desktop assistants (PDAs)), tablet PCs, specialized computing devices (e.g., kiosks), or the like. A computer 105 may have, for example, a computer motherboard 106 that includes one or more central processing units (CPUs) 107 and an interface 108 for connecting to one or more networks (such as local area network 112 or wide area network 130) or devices. According to one embodiment, the computers 105 are connected to a local area network 112 that may be connected to a wide area network 130. Alternatively, a computer 105 may be connected directly to a wide area network 130. A local area network 112 may have at least one server 114 that executes a server-based calendaring application 116 accessible by client-based calendaring application 118 executing on each of the client computers 105. The client-based calendaring application 118, which may be a thin client, thick client or web browser application, communicates with the calendaring application 116. A wide area network 130 may connect the local area networks 112. In another embodiment, a client-based calendaring application 118 on the client computers 105 may be a stand-alone application or may be supported by a server on the wide area network 130. According to another embodiment, the server-based calendaring application 116 and/or client-based calendaring application 118 may include or be in communication with an address book 117 operational on a computer 105 or on a local area network server 114, or both. According to one example embodiment, the calendaring application 116/118 may be, for example only, the Outlook® software provided by Microsoft Corporation or a Lotus Notes® application provided by IBM Corporation. Other examples may include a specialized portable operating systems or other software with organizational software components, such as the Palm OS and BlackBerry Connect provided by Palm, Inc.; BlackBerry Desktop Software provided by Research in Motion of Ontario, Canada; or Windows Mobile provided by Microsoft Corporation.

At least some of the client computers 105 further include a voice-over-Internet-protocol (VoIP) application 122 that may provide for establishing a VoIP connection, for example using IP-protocol communication through the networks, between the client computer 105 and another one of the client computers 105 in a peer-to-peer mode of operation. Alternatively, a VoIP connection may be established to a public switched telephone network (PSTN) 132 in another mode of operation, for example through the network 112 and 130, or directly from network 112 to the PSTN. A server or other computing resource 127 may be provided on wide area network 130 to facilitate peer-to-peer VoIP connections or to facilitate the switching of VoIP calls through the network 130 in some other fashion. According to one embodiment, VoIP application 122 communicates with a VoIP server application 129 on resource 127, in order to facilitate peer-to-peer VoIP communications for example. Client computer 105 may include a VoIP appliance 109, such as a handset, headset, speaker-phone or video camera that may be used to transmit and receive audio and/or video information. According to one example embodiment, the VoIP connection may be provided by the Skype® system offered by eBay Corporation.

According to one example embodiment, the peer-to-peer VoIP application may be implemented as described in PCT Application Serial No. PCT/IB2004/002282 filed Jul. 14, 2004, the entire contents of which are hereby incorporated herein by reference. In one example embodiment of a peer-to-peer VoIP system, the structure is substantially devoid of any form of centralized exchange except for one or more administration nodes such as may be provided by resource 127 (e.g., server) and VoIP server application 129 for performing some specific network administration functions such as subscriber sign-up and payment for communication network usage. In such a decentralized structure, most routine functions, for example placing a telephone call, are handled entirely by end-user devices operable to communicate substantially directly to each other or via some form of local exchange such as an optical metro ring or distributed relay nodes on the public Internet.

Referring now to FIG. 1B, the calendaring applications 116 and/or 118 store appointment data 140 representing an appointment for a teleconference, and wherein the appointment specifies a time 141 and one or more participants 142 scheduled to join the teleconference. The calendaring applications, alone or in concert, may generate a user interface 147 through which a user may interact therewith to set programmable parameters as described herein below and/or to set up appointments or otherwise interact with the calendaring applications. For data and parameter input the interface 147 includes input screens or fields 148, and data output screens or fields 149. The calendar applications 116 and/or 118 further include a VoIP interface 146, which may include software code or functionality that enables the calendaring applications 116 and/or 118 to communicate with the VoIP application 122 to initiate a VoIP connection to the teleconference through the VoIP application 122. Further, the calendaring application 116 and/or 118 may access participant profile data 150, stored in the application or somewhere on the client computer 105 or on a network resource, to read at least one “IP-enabled” parameter 151 indicating whether at least one of the participants is enabled to conduct a VoIP. In one embodiment, the parameter is stored in the calendaring application or an address book application.

According to another embodiment, the calendaring application displays to a meeting organizer or user setting up a teleconference a VoIP-enabled indication 145 for at least one participant indicating that the participant is enabled to join the teleconference using a VoIP connection, for example through user interface 147. In addition, a VoIP address 152 (or identification such as a user name or designation) parameter and/or a PSTN-type phone number is stored in the calendaring application 116 and/or 118 or an address book application (e.g., 117 in FIG. 1A) that may be used to set up a VoIP connection to the teleconference. User interface 147 may further include one or more input screens for receiving from a meeting organizer for the teleconference an indication that the teleconference will be available for participation using a VoIP connection. Such indication may be stored by the calendaring application and used to inform invitees to the meeting that they may join by VoIP connection. The calendaring application 116 and/or 118 may also store one or more user-specified preference parameters 143, such as indicating if the participant chooses to join the teleconference through a VoIP connection, for example obtained in response to input from an invitee to a teleconference. Such input may be obtained when the user accepts the appointment on their calendar. According to an embodiment, user choices corresponding to each invitee's response are recorded in the appointment data 140, such as the user preferences for VoIP for a particular appointment 144.

According to still another example embodiment, the calendaring application 116 and/or 118 is adapted to allow participants to be invited to the teleconference using the electronic address book accessible from or in the calendaring application 116 and/or 118 or by entering invitation information into the calendaring application 116 and/or 118. According to another example embodiment, the interface 147 may include a meeting reminder pop-up 160 generated by the calendaring application 116 and/or 118 that is displayed to at least one participant invited to the teleconference on the participant's client computer 105, and further wherein the reminder includes a user-selectable control 162 that if selected connects the participant to the teleconference using a VoIP connection. In one example embodiment, the calendaring application 116 and/or 118 works in concert with the VoIP applications 122 and/or 129 to automatically connect a teleconference the call using a VoIP peer-to-peer connection, or other VoIP connection.

According to one example embodiment, the server-based calendaring application 116 may be integrated with the VoIP application 122, such that both functions of these applications are provided by a single application.

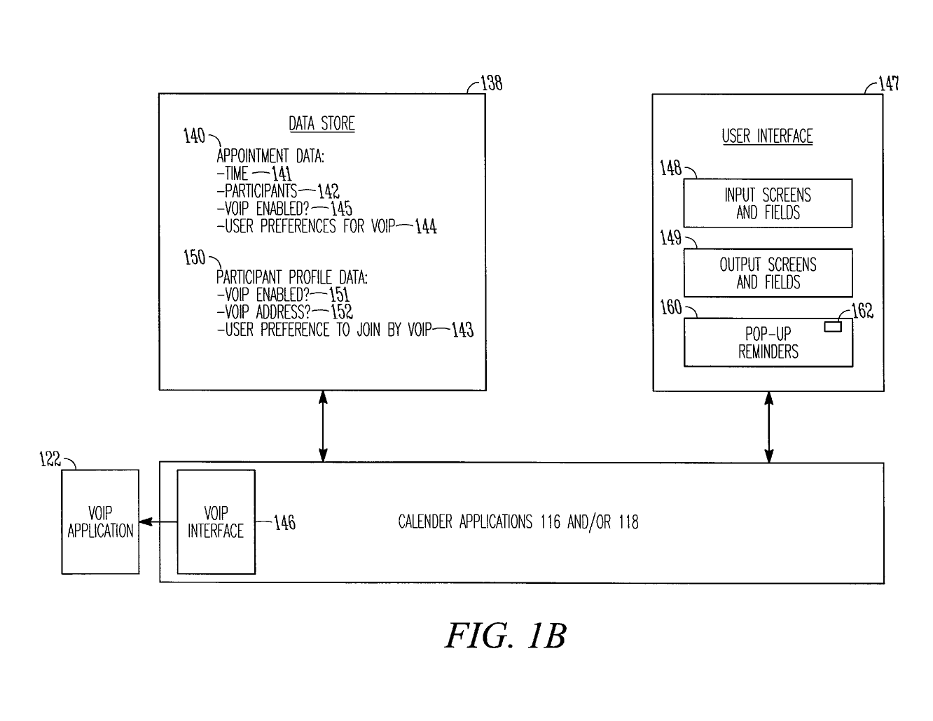

Referring now to FIG. 2, there is illustrated a method 200 according to one example embodiment. The method 200 includes creating and/or storing an appointment 210 for a teleconference in a calendaring application, wherein the appointment specifies one or more participants scheduled to join the teleconference. A calendaring application at least in part communicates with a VoIP software application 220 to initiate a teleconference 230 using a VoIP connection from an end-user computer to another participant in the teleconference. Method 200 may for example be implemented on a system such as that shown in FIGS. 1A and 1B, or on any other infrastructure.

According to one example embodiment of the method 200, at least some of the participants use an end-user computer wherein a VoIP application executes on the end-user computer and is used at least in part to connect to the teleconference. Or, the teleconference may be conducted using at least one VoIP peer-to-peer connection to connect the participants. In another example embodiment, the teleconference may be conducted at least in part using at least one connection through a public switched telephone network (PSTN) to connect one of the participants.

According to other example embodiments of method 200, at least one parameter is stored indicating whether at least one of the participants is enabled to conduct a VoIP, and a VoIP-enabled indication may be displayed to a meeting organizer or participant to indicate that a participant is enabled to join the teleconference using a VoIP connection. In still another embodiment one or more VoIP address parameters are stored and may be used to set up a VoIP connection to the teleconference. In another example embodiment of the method 200, a meeting organizer for the teleconference may indicate to the calendar application that the teleconference will be available for participation on a VoIP connection. In another example embodiment of the method, participants to the teleconference are invited using an electronic address book accessible from or integrated in the calendaring application or by entering invitation information into the calendaring application. Further, the calendaring application may send to the participants an invitation to join the meeting, wherein the invitation further indicates to the invited participant that the meeting will be conducted at least in part over a VoIP connection. In addition, according to still yet another example embodiment, the calendaring application may generate a meeting reminder that is displayed to at least one participant, and further wherein the reminder includes a user selectable control that if selected connects the participant to the teleconference using a VoIP connection.

In yet another example embodiment, the address book accessible by the calendaring application stores a phone number that can be used to connect one participant to another using a VoIP connection. In addition, the calendaring application may store a user-specified parameter indicating if a participant chooses to join the teleconference through a VoIP connection. In still yet another example embodiment of the method 200, all the participants for the teleconference may be automatically connected to the call using a VoIP peer-to-peer connection. In a still further example embodiment, the calendaring application executes at least in part on a server and at least some of the participants interact with the calendaring application through an end-user computer networked to the server.

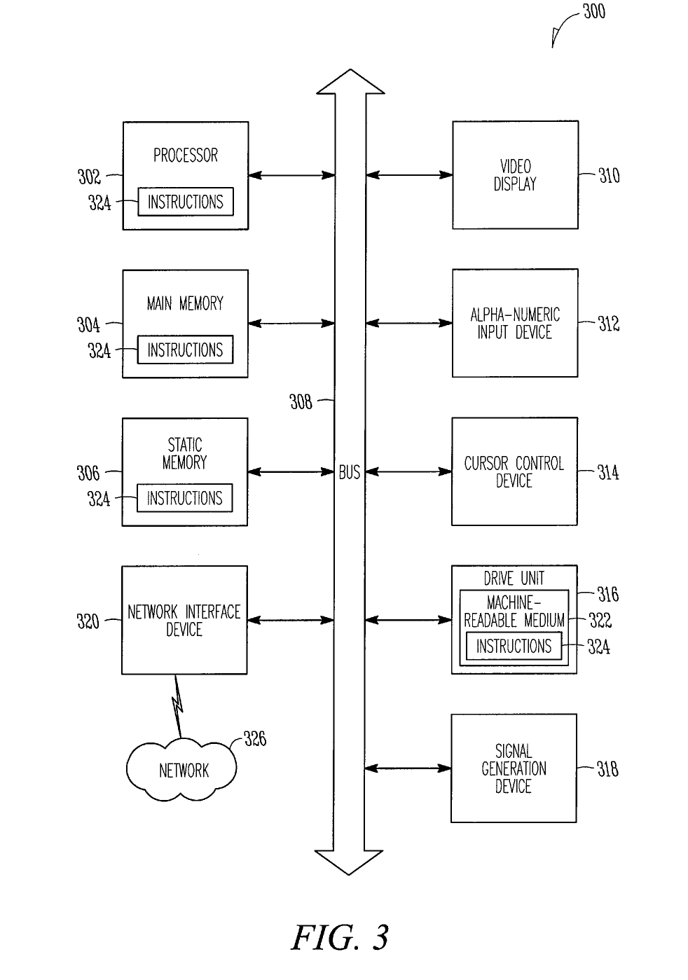

FIG. 4 shows a diagrammatic representation of machine in the example form of a computer system 400 within which a set of instructions, for causing the machine to perform any one or more of the methodologies discussed herein, may be executed. In alternative embodiments, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a server computer, a client computer, a personal computer (PC), a tablet PC, a set-top box (STB), a Personal Digital Assistant (PDA), a cellular telephone, a web appliance, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 400 includes a processor 402 (e.g., a central processing unit (CPU) a graphics processing unit (GPU) or both), a main memory 404 and a static memory 406, which communicate with each other via a bus 408. The computer system 400 may further include a video display unit 410 (e.g., a liquid crystal display (LCD) or a cathode ray tube (CRT)). The computer system 400 also includes an alphanumeric input device 412 (e.g., a keyboard), a cursor control device 414 (e.g., a mouse), a disk drive unit 416, a signal generation device 418 (e.g., a speaker) and a network interface device 420.

The disk drive unit 416 includes a machine-readable medium 422 on which is stored one or more sets of instructions (e.g., software 424) embodying any one or more of the methodologies or functions described herein. The software 424 may also reside, completely or at least partially, within the main memory 404 and/or within the processor 402 during execution thereof by the computer system 400, the main memory 404 and the processor 402 also constituting machine-readable media.

The software 424 may further be transmitted or received over a network 426 via the network interface device 420.

While the machine-readable medium 422 is shown in an example embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing, encoding or carrying a set of instructions for execution by the machine and that cause the machine to perform any one or more of the methodologies of the present invention. The term “machine-readable medium” shall accordingly be taken to include, but not be limited to, solid-state memories, optical and magnetic media, and carrier wave signals.

Thus, methods, systems and data structures to facilitate VoIP teleconferences using a calendaring application have been described. Although the present invention has been described with reference to specific example embodiments, it will be evident that various modifications and changes may be made to these embodiments without departing from the invention. Accordingly, the specification and drawings are to be regarded in an illustrative rather than a restrictive sense.

The Abstract of the Disclosure is provided to comply with 37 C.F.R. §1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment.

1. A system comprising:
at least one end-user computer executing a calendaring application, wherein the calendaring application includes data representing an appointment for a teleconference, and wherein the appointment specifies one or more participants scheduled to join the teleconference;
the end-user computer including at least a portion of a VoIP software application adapted to establish a VoIP connection to the teleconference; and
the calendaring application executing on the end-user computer to at least in part communicate with the VoIP software application in order to initiate the VoIP connection.

2. A system according to claim 1 wherein the calendaring application comprises a client application supported by a calendaring application executing on a server.

3. A system according to claim 2 wherein the client application includes a web browser.

4. A system according to claim 1 wherein a plurality of the participants use an end-user computer connected to a network.

5. A system according to claim 1 further comprising at least one computer resource on the network that facilitates the establishment of the teleconference using at least one VoIP peer-to-peer connection to connect the participants.

6. A system according to claim 1 further comprising one or more of the end-user computers connected to a public switched telephone network (PSTN) and further wherein the teleconference is conducted at least in part using the PSTN to connect one of the participants.

7. A system according to claim 1, wherein the calendaring application is adapted to access at least one parameter indicating whether at least one of the participants is enabled to communicate using VoIP.

8. A system according to claim 7, wherein the parameter is stored in the calendaring application or an address book application.

9. A system according to claim 7 wherein the calendaring application is adapted to execute on the end-user computer to display a VoIP-enabled indication for at least one participant indicating that the at least one participant is enabled to join the teleconference using a VoIP connection

10. A system according to claim 9 wherein the VoIP-enabled indication is displayed to a meeting organizer setting up the teleconference.

11. A system according to claim 1, further comprising a storage module to store one or more VoIP address parameters that may be used to set up a VoIP connection to the teleconference.

12. A system according to claim 11 wherein the parameters are stored in an address book.

13. A system according to claim 1, wherein the calendaring application is adapted to receive from a meeting organizer for the teleconference an indication that the teleconference will be available for participation using a VoIP connection.

14. A system according to claim 1 wherein the calendaring application is adapted to invite participants to the teleconference using an electronic address book accessible from the calendaring application or by entering invitation information into the calendaring application

15. A system according to claim 1 wherein the calendaring application is adapted to send to the participants an invitation to join the meeting, wherein the invitation further indicates to the invited participant that the meeting will be conducted at least in part over a VoIP connection.

16. A system according to claim 1 wherein the calendaring application is adapted to generate a meeting reminder that is displayed to at least one participant, and further wherein the reminder includes a user selectable control that if selected connects the participant to the teleconference using a VoIP connection.

17. A system according to claim 1 wherein all the participants for the teleconference are automatically connected to the teleconference using one or more VoIP peer-to-peer connections.

18. A system according to claim 1 further comprising an address book accessible by the calendaring application, the address book adapted to store a phone number and/or an VoIP connection identifier that can be used to connect one participant to another using a VoIP connection.

19. A system according to claim 1 wherein the calendaring application is adapted to store a user-specified parameter indicating if the participant chooses to join the teleconference through a VoIP connection.

20. A method comprising:
storing an appointment for a teleconference in a calendaring application, wherein the appointment specifies one or more participants scheduled to join the teleconference; and
establishing a VoIP teleconference connection to the teleconference from an end-user computer used by at least one of the participants, wherein the calendaring application communicates with a VoIP software application to initiate the VoIP teleconference connection.

21. A method according to claim 20 wherein at least some of the participants use a end-user computer wherein a VoIP application executes on the end-user computer and is used at least in part to connect to the teleconference.

22. A method according to claim 20 further comprising conducting the teleconference using at least one VoIP peer-to-peer connection to connect the participants.

23. A method according to claim 20 further comprising conducting the teleconference using at least one connection through a public switched telephone network (PSTN) to connect one of the participants.

24. A method according to claim 20, further comprising storing at least one parameter indicating whether at least one of the participants is enabled to conduct a VoIP.

25. A method according to claim 24 further comprising displaying a VoIP-enabled indication for at least one participant indicating that the at least one participant is enabled to join the teleconference using a VoIP connection

26. A method according to claim 25 further comprising displaying the VoIP-enabled indication to a meeting organizer.

27. A method according to claim 20, further comprising storing one or more VoIP address parameters that may be used to configure a VoIP connection to the teleconference.

28. A method according to claim 27 wherein the parameters are stored in an address book.

29. A method according to claim 20, further comprising indicating to the calendar application that the teleconference will be available for participation on a VoIP connection

30. A method according to claim 20 further comprising inviting participants to the teleconference using an electronic address book accessible from the calendaring application or by entering invitation information into the calendaring application

31. A method according to claim 20 further comprising sending to the participants an invitation to join the meeting using the calendaring application, wherein the invitation includes an indication that the meeting will be conducted at least in part over a VoIP connection.

32. A method according to claim 20 wherein the calendaring application generates a meeting reminder that is displayed to at least one participant, and further wherein the reminder includes a user selectable control that when selected connects the participant to the teleconference using a VoIP connection.

33. A method according to claim 20 wherein all the participants for the teleconference are automatically connected to the teleconference using one or more VoIP peer-to-peer connections.

34. A method according to claim 20 wherein an address book accessible by the calendaring application stores a phone number and/or a VoIP connection identifier that can be used to connect one participant to another using a VoIP connection.

35. A method according to claim 20 wherein the calendaring application stores a user-specified parameter indicating if the participant chooses to join the teleconference through a VoIP connection.

36. A method according to claim 20 further comprising choosing one or more participants for the teleconference from an address book accessible by the calendaring application.

37. A method according to claim 20 wherein the calendaring application executes at least in part on a server and at least some of the participants interact with the calendaring application through an end-user computer networked to the server.

38. A computer-readable medium including instructions that, when executed on a machine, cause the machine to:
store an appointment for a teleconference in a calendaring application, wherein the appointment specifies one or more participants scheduled to join the teleconference; and
establish a VoIP teleconference connection to the teleconference from an end-user computer used by at least one of the participants, wherein the calendaring application communicates with a VoIP software application to initiate the VoIP teleconference connection.

39. A computer-readable medium according to claim 38 further comprising instructions to store one or more VoIP address parameters that may be used to configure a VoIP connection to the teleconference.

40. A computer-readable medium according to claim 38 further comprising instructions to invite participants to the teleconference using an electronic address book accessible from the calendaring application.

41. A computer-readable medium according to claim 38 further comprising instruction to send the participants an invitation to join the meeting using the calendaring application, wherein the invitation includes an indication that the meeting will be conducted at least in part over a VoIP connection.

42. A computer-readable medium according to claim 38 wherein the calendaring application generates a meeting reminder that is displayed to at least one participant, and further wherein the reminder includes a user selectable control that when selected connects the participant to the teleconference using a VoIP connection.

43. A computer-readable medium according to claim 38 further comprising instructions to choose one or more participants for the teleconference from an address book accessible by the calendaring application.
